(19) United States
(12) Patent Application Publication
(10) Pub. No.: US 2010/0100431 A1
(43) Pub. Date: Apr. 22, 2010

(54) METHODS AND APPARATUS FOR A GUEST SERVICES SYSTEM FOR COUPONING AND GAMING

(75) Inventors: Elizabeth Vicens, Arleta, CA (US); John Hilbert, Torrance, CA (US); Mark Meyerhofer, La Canada, CA (US)

Correspondence Address: FITZPATRICK CELLA HARPER & SCINTO, 1290 Avenue of the Americas, NEW YORK, NY, 10104-3800, US

(73) Assignee: FutureLogic, Inc., Glendale, CA (US)

(21) Appl. No.: 12/580,000

(22) Filed: Oct. 15, 2009

Related U.S. Application Data
(60) Provisional application No. 61/106,016, filed on Oct. 16, 2008.

(51) Int. Cl. G06Q 30/00; G06Q 50/00

(52) U.S. Cl. 705/14.12

(57) ABSTRACT

Guest services system for couponing and gaming where guests using an access point such as their room or kiosk select which promotions to view, which incentives and/or coupons to print and request and/or receive play credits. Additionally, secured means include using a PIN, password, and/or a secured card such as a room card or player tracking card to access and view incentives, request play credit, receive incentives and/or play credit, and/or purchase play credit. The system includes a connection to host systems, a controller, a user interface, input device, output device, card reading device as well as personal communication devices such as a computer.

### CROSS-REFERENCE TO RELATED APPLICATION(S)

The present application claims the benefit of U.S. Provisional Patent Application No. 61/106,016, filed Oct. 16, 2008, the contents of which are hereby incorporated by reference as if stated in full herein.

### BACKGROUND OF THE INVENTION

1. Field of the Invention

This invention relates generally to printers and printer connected hardware used in cash-less slot machines and gaming, and more specifically to hardware and software operating within this equipment performing promotional ticket printing, promotional data basing and triggering.

2. Background

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have provided cash-less enabled games to the market for the last five year, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of necessary equipment for a cash-less enabled game is a printer to produce the vouchers, and a bill acceptor that supports automatic reading of the vouchers. In a cash-less enabled gaming system, when a player cashes out, the game is signaled and depending on the size of the pay out, it can either present coins in the tradition method of a slot machine, or it can cause the printers which are installed in such machines to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Over the last five years, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which may be used to print coupons and promotions for the captive player audiences.

Currently, in typical casino operations, the games are networked to a main server which monitors various metrics of activity on the games for regulatory, accounting and promotional activities. The server related to promotions for player club cards is referred to as the Player Tracking Sever. Games share real-time play metrics with the Player Tracking Server in order to support frequent player incentives.

### SUMMARY OF THE INVENTION

The present invention identifies methods and apparatus for guest services for couponing and gaming where a guest using an access point such as their room or kiosk selects which promotions to view and which incentives and/or coupons to print as well as requests and/or receives one or a plurality of play credits. Additionally, secured means for such guest services include using a secured card such as a room card or player tracking card to access and view available incentives, request play credit, receive incentives and/or play credit, and/or purchase play credit.

In one aspect of the invention, apparatus for guest services includes an output device such as a coupon printing device.

In another aspect of the invention, apparatus for guest services includes one or a plurality of input devices such as a keypad and/or card reading device.

In another aspect of the invention, apparatus for guest services includes a user interface such as a television, monitor, computer, telephone, and a PDA, among others.

In another aspect of the invention, apparatus for guest services includes means to connect to one or a plurality of host systems and/or one or a plurality of access points and/or points of redemption, such means including a LAN, WAN, and Internet, among others.

In another aspect of the invention, one or a plurality of access points house one or a plurality of apparatus for guest services, an access point including the lodging accommodations of a guest, a kiosk on the floor, and/or in a game, among others.

In another aspect of the invention, methods and apparatus for guest services includes security means to prevent unauthorized access, use, fraud and theft, includes any one or combination of the following, among others: a PIN, a password, associating a unique printer identifier with a room number, player tracking card data and/or other data, reading a card such as a room card and/or player tracking card, including the guest's name on and/or with all financial transactions including printing of coupons.

In another aspect of the invention, methods and apparatus for guest services includes providing incentives to a guest, the incentives include receiving play credits, where the play credits include discounted play credits and/or bonus play credits, among others.

In another aspect of the invention, any or all components of an access point and/or point of redemption includes audio and/or visual means for guest notification.

### BRIEF DESCRIPTION OF THE DRAWINGS

These and other features, aspects, and advantages of the present invention will become better understood with regard to the following description, accompanying drawings and appendix where:

FIG. 1 is an illustration of components for the issuance of incentives and/or promotional coupons to a guest in accordance with an exemplary embodiment of the present invention;

FIG. 2 is an illustration of components for the redemption of incentives and/or promotional coupons from a guest in accordance with an exemplary embodiment of the present invention;

FIG. 3 is an illustration of components for secured guest services in accordance with an exemplary embodiment of the present invention;

FIG. 4 is a flowchart of a data comparison and verification process to initiate secured guest services in accordance with an exemplary embodiment of the present invention;

FIG. 5 is an illustration of components for play credits in accordance with an exemplary embodiment of the present invention;

FIG. 6 is a flowchart of a request play credits process in accordance with an exemplary embodiment of the present invention;

FIG. 7 is a block diagram of a printer used with guest services in accordance with an exemplary embodiment of the present invention;

FIG. 8 is a block diagram of a card reading device used with guest services in accordance with an exemplary embodiment of the present invention;

FIG. 9 is a block diagram of a host system used with guest services in accordance with an exemplary embodiment of the present invention;

FIG. 10 is a side cutaway view of a printer illustrating the paper path used with the generation of incentives and/or promotional coupons in accordance with an exemplary embodiment of the present invention; and

APPENDIX A is a list of definitions of terms as used herein.

Identically labeled elements appearing in different ones of the figures refer to the same elements but may not be referenced in the description for all figures.

### DETAILED DESCRIPTION OF THE INVENTION

The present invention identifies methods and apparatus for a guest services system for couponing and gaming where a guest using an access point such as their room or kiosk selects which promotions to view and which incentives and/or coupons to print as well as requests and/or receives one or a plurality of play credits. Additionally, secured means for such guest services include using a secured card such as a room card or player tracking card to access and view available incentives, request play credit, receive incentives and/or play credit, and/or purchase play credit.

The Inventors have observed that gaming establishments use multiple promotion methods to induce individuals to patronize the gaming floor of the establishment. One such method includes the direct mailing of coupons to consumers. One problem that plagues this method is that the promotion must be planned well in advance to accommodate the printing and mailing of the promotional coupons to consumers. Another problem is direct mailing and printing is not cost effective. Another problem is that most preprinted promotional coupons cannot be directly inserted into or read by a bill acceptor in a gaming or vending machine. These preprinted promotional coupons must be processed by hand, the process which lends itself to fraud and security issues such as forgery.

Another such method includes providing consumers the means to download promotions from a networked environment (typically the Internet) for a gaming or other business establishment. In addition to some of the problems cited for the previously described existing methods, problems for this existing method also include the lack of the consumer's presence at a gaming establishment which reduces the promotion's overall effectiveness and coupon redemption.

In another such method related to the generation and issuance of promotional coupons, comps can be issued by a gaming establishment to a consumer. Comps can include free meals, drinks, show tickets, special room rates, room upgrades, match play coupons, and free cash. One problem with this method is that the comp is usually processed or issued by a cashier, pit boss, or floor person whereby it must be determined if the consumer should receive a comp. Additionally, this method can be time consuming.

However, there are no existing means to provide promotional couponing and/or play credits to a guest in a gaming environment from the comfort and privacy of their lodging accommodations and/or an access point such as a kiosk. Various systems in accordance with exemplary embodiments of the present invention meet such a need.

The Inventors also have observed that play credits are issued when a player joins a player tracking club and/or uses a player tracking card while shopping and/or gambling. To join a player tracking club, the player must visit the sign up location within the gaming establishment and complete an application. This location sometimes is referred to as the players' club booth. To request and/or purchase additional play credit, a player usually returns to the players' club booth where the player can use currency and/or credit to purchase additional play credit which is then either placed on the player tracking card or issued on one or more play tickets or vouchers.

One drawback with this existing method for the gaming establishment is the personnel required to manually process play credit purchases. The personnel must request from the player the currency or credit card to process the purchase. This method can be time consuming.

Another drawback with this existing method is the inconvenience caused to a player in having to locate the players' club booth, especially in larger gaming establishments where the location of the booth may be at one end of the establishment while a player is playing at another end. Another drawback for a player is that the player also must carry their money with them.

This invention addresses these drawbacks by providing the means where a player can request and/or purchase play credits at regular and/or discounted cost from the convenience of their room and/or an access point such as a kiosk, thereby eliminating the need for the player to visit the players' club booth and/or carrying money.

Further, the Inventors have observed that to provide such guest services requires an additional layer of security to prevent fraud and/or abuse of the system. Fraud includes an unauthorized person using another person's credit card to purchase play credits and/or receive incentives. Abuse of the system includes a person attempting to exceed a preset and/or maximum allowable credit card charge amount. This invention addresses these by providing secured means including but not limited to using a PIN, a password, associating devices with rooms, and including the guest's name on and/or with all financial transactions.

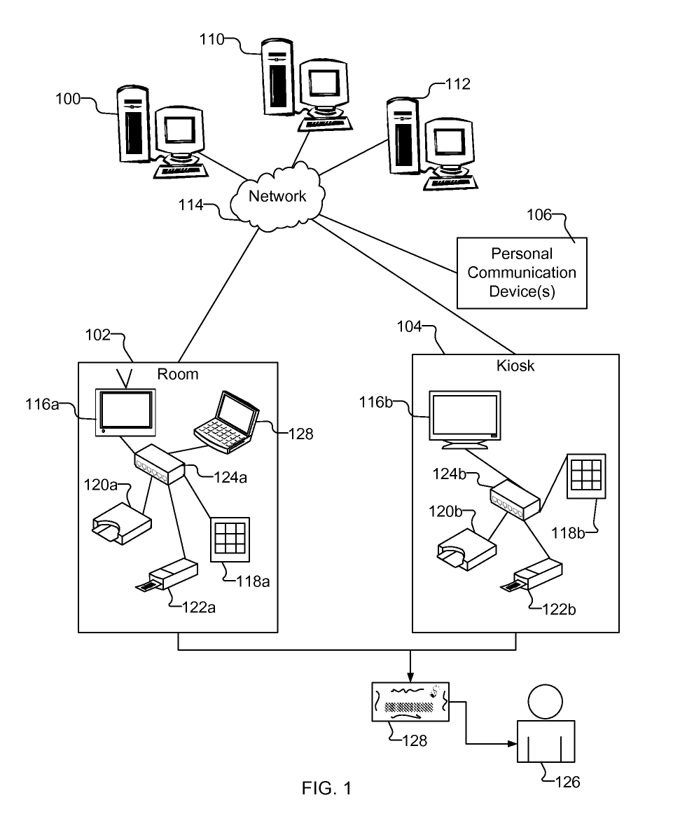

FIG. 1 is an illustration of components for the issuance of incentives and/or promotional coupons to a guest in accordance with an exemplary embodiment of the present invention. Any component or combination of components may be optional.

Illustrated is a plurality of host systems using a network 114 connection to interface with each other as well as one or a plurality of access points such as a room 102, a kiosk 104, and/or one or a plurality of personal communication devices 106. Additional access points include a game (not shown), among others.

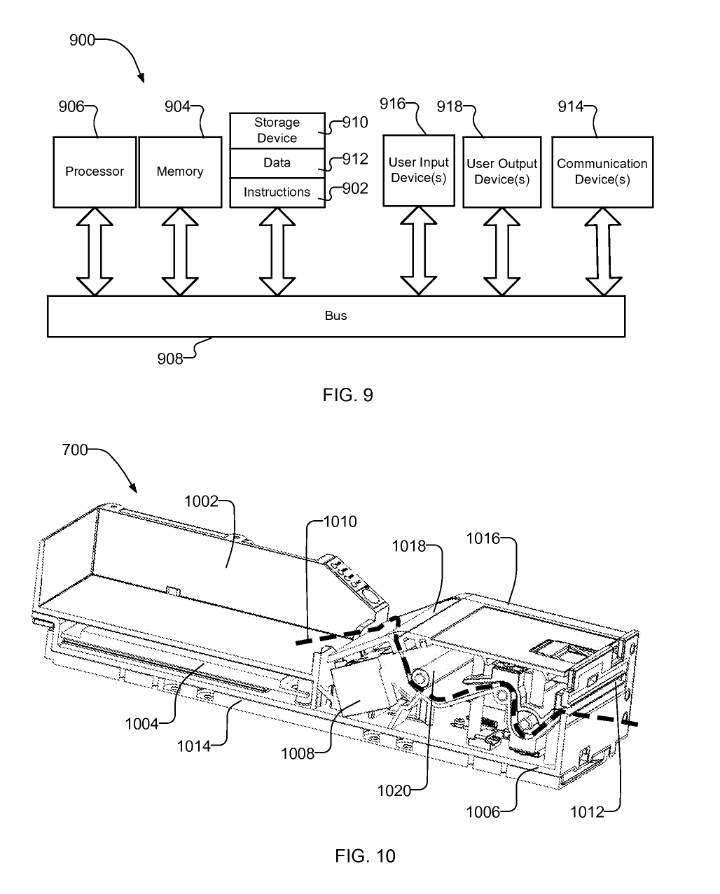

The one or a plurality of host systems includes systems such as a Promotional Coupon System (“PCS”) 100 for the issuance, redemption, and management of promotional coupons 128, a Lodging Management System (“LMS”) 110 for the management of lodging and/or guest services, and Others 112 such as an financial transactions system to process credit card and/or debit card transactions. These host systems interface with each other for data exchange using a network 114. The network is one or a combination of networks such as a LAN, WAN, and Internet, among others. A more detailed discussion of a Promotional Coupon System and components thereof is presented in U.S. patent application Ser. No. 11/502,888 entitled, “METHOD AND APPARATUS FOR A PROMOTIONAL COUPONING SYSTEM” filed Aug. 10, 2006 and in PCT Application No. PCT/US06/38492 entitled “METHOD AND APPARATUS FOR A PROMOTIONAL COUPONING SYSTEM”, filed Oct. 2, 2006, the contents of each of which are hereby incorporated by reference as if stated herein in full. Additional details of a host system are disclosed in FIG. 9 as well as throughout this specification.

Each room 102 serves as an access point, including devices and/or components which a guest 126 uses to interface with the guest services system for couponing and gaming. These devices include one or a plurality of user interfaces 116a, one or a plurality of input devices 118a, a card reading device 120a, an output device 122a, as well a controller 124a for interfacing with one or a plurality of devices and host systems such as PCS 100 using a network 114. Additionally, a device 128 belonging to the guest such as a computer and/or PDA can connect to the system using the appropriate secured means.

User interfaces 116a and 116b include devices such as a television, monitor, computer, telephone, and a PDA, among others. These type devices serve as a means where a guest 126 can view available incentives, request play credits, and view their account activity, among others.

Input devices 118a and 118b include devices such as a keypad, among others. The keypad serves as a means where a guest 126 can select one or a plurality of incentives, initiate a request to print incentives, and/or initiate a request for play credits, among others.

The card reading devices 120a and 120b serve as a means where a guest 126 can purchase play credit using a credit and/or debit card. The card reading device also can read a player tracking card and/or a room card, among others. Additional details of a card reading device are disclosed in FIG. 8 as well as throughout this specification.

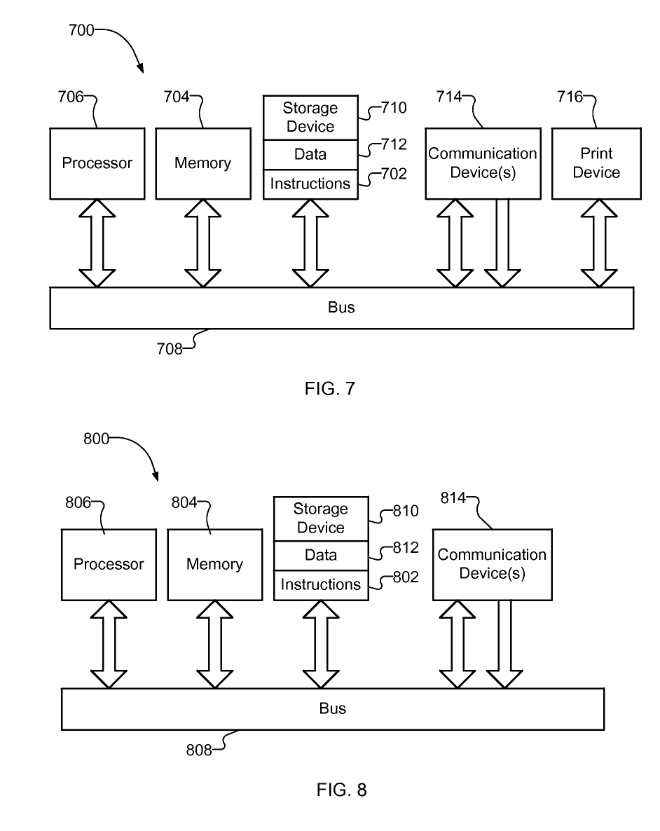

The output devices 122a and 122b include a device such as a coupon printing device, among others. The output device serves as a means of generating a coupon 128 associated with a guest-selected incentive or purchased play credits. A more detailed discussion of an output device is the printer and components thereof presented in U.S. patent application Ser. No. 10/616,811, entitled, “GAMING MACHINE PRINTER” filed Jul. 9, 2003, the contents of which are hereby incorporated by reference as if stated herein in full as well as in FIG. 7 and FIG. 10.

In another embodiment, an output device and card reading device are combined. A more detailed discussion is presented in U.S. patent application Ser. No. 10/661,364, entitled, “MULTI-MEDIA GAMING PRINTER” filed Sep. 12, 2003, the contents of which are hereby incorporated by reference as if stated herein in full.

The controllers 124a and 124b serve as a means for proper data transmission to and from one or a plurality of host systems such as 100 and/or one or a plurality of components such as 122a and 122b.

Kiosks 104 are located anywhere on a gaming floor, point-of-sale such as a retail shop, etc. One or a plurality of kiosks include a user interface 116b, an input device 118b, a card reading device 120b, an output device 122b, and/or controller 124b among other components not shown but known to those skilled in the arts. As with a room 102, a kiosk serves as an access point to interface with the guest services system for couponing and gaming. Each component is disclosed in FIG. 1 as well as throughout this specification.

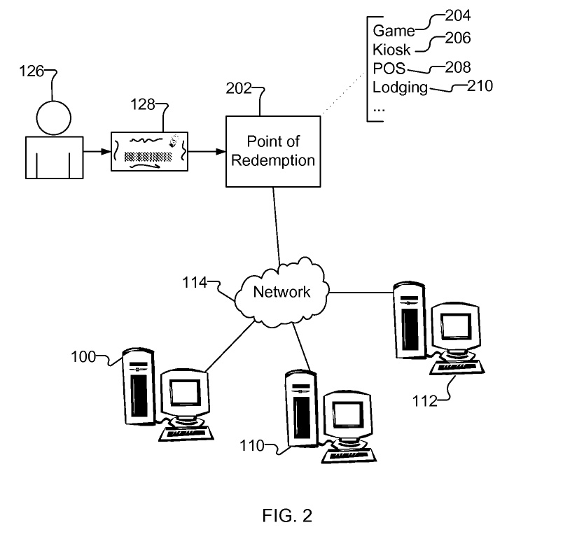

In another embodiment, a card reading device such as 120a and 120b serves as a means by which purchased play credits and/or incentives are placed on a card such as a player tracking card. Further, a guest 126 may receive a unique PIN number to permit data exchange with the card. The guest can insert their card into a card reading device in a kiosk 206, game 204, point-of-purchase location 208 (all of FIG. 2), etc., where the card can be read for redemption.

In another aspect, a card such as a room card and/or a player tracking card is used to start the issuance of coupons 128 using the components of an access point. After reading a card, campaigns, coupon data, incentives, etc. are download to the access point and printed using an output device such as 122a and 122b.

In the operation of one embodiment, a host system such as a PCS 100 transmits data regarding incentives to one or a plurality of guests 126. A guest using components in an access point such as a user interface 116a (such as a television) in the guest's room 102 views the incentives and/or promotions. After selecting one or a plurality of incentives, the guest instructs the PCS to print a coupon 128 for each selected incentive using an output device 122a. Further, data regarding each printed coupon is transmitted back to the PCS as later disclosed in FIG. 2.

In the operation of another embodiment, a guest 126 using components in an access point such as a user interface 116a (such as a television) and secured means logs into an account created for the guest to access available incentives.

In another embodiment, the connection is a computer such as 128. In another embodiment, the connection is a kiosk 104.

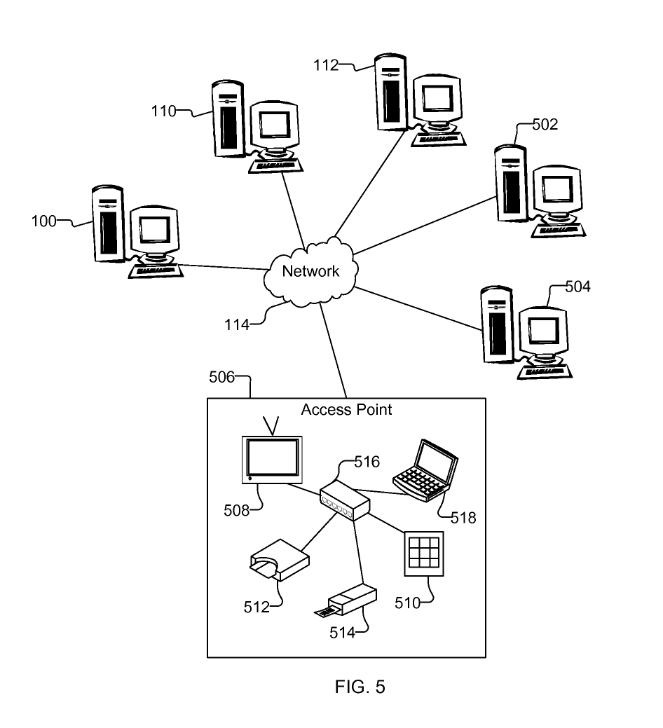

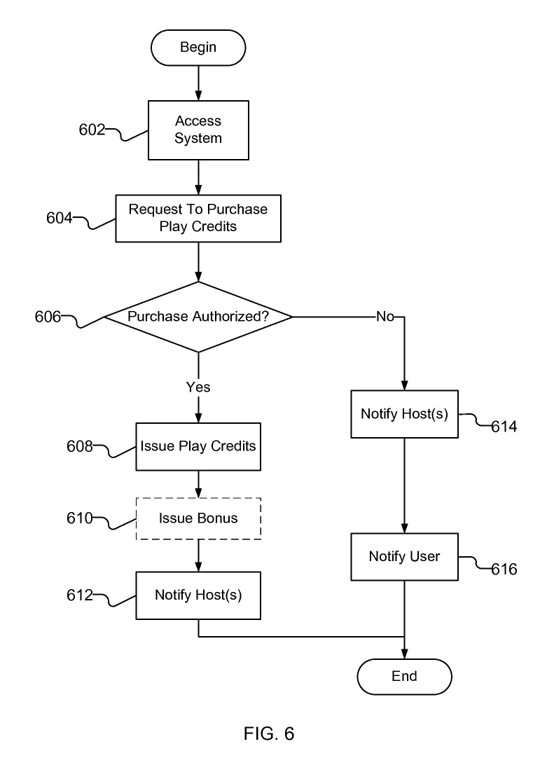

In the operation of another embodiment, a guest 126 desires to purchase additional play credits. The guest using components in an access point such as that provided in the guest's room 102 and/or via a kiosk 104 requests and purchases the additional play credits at face value, at a discounted cost, or as bonus credits. After the guest's request is approved, an output device 122a in the room 102 or an output device 122b in a kiosk 104 generates one or a plurality of coupons 128 containing the additional play credits or a card reading device such as 120a and 120b is used to place the purchased play credits on a card such as a player tracking card (not shown). A gaming establishment may vary the discount and/or bonus incentive based on play and/or other metrics for the guest. Additional detail is disclosed in FIG. 5 and FIG. 6 as well as throughout this specification.

For example, a guest 126 can purchase $1 play credits at a discount of $0.85 or a guest can purchase $100 of play credits and receive bonus credits such as $15 where the issued amount totals $115.

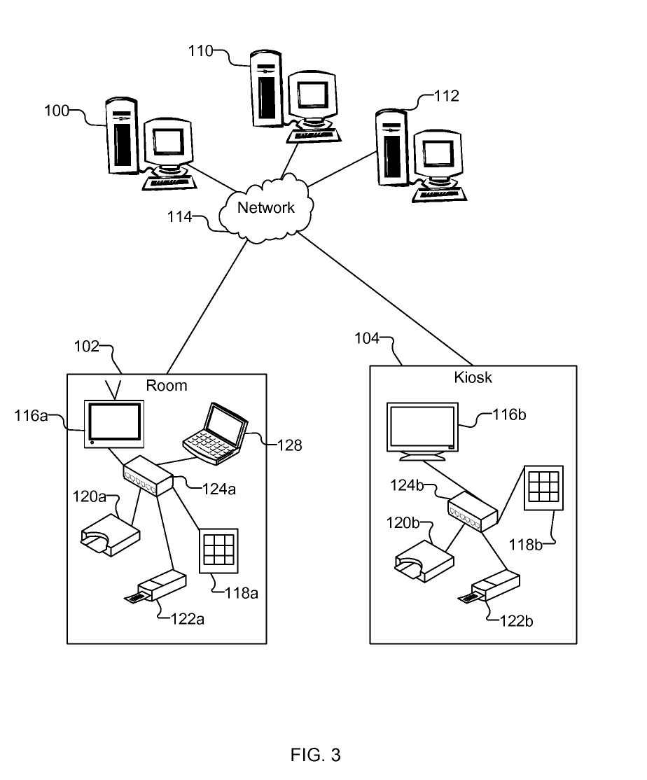

In another embodiment, security means to prevent fraud or theft by others such as hotel staff include, among others, incorporating the guest's 126 name and/or other personal data on the coupon 128 or with the incentive, issuing a unique PIN number to each guest, after associating an output device such as 122a and 122b such as a printer with a room 102 or kiosk 104, associating the IP address and/or unique address of each to the other, and logging the address of the issuing output device or printer along with the print time, etc., in a database. Additional details are disclosed in FIG. 3 as well as throughout this specification.

In another embodiment, any or all components of an access point such as a room 102 or kiosk 104 includes audio and/or visual means for guest notification. For example, an output device such as 122a and 122b includes audio and visual means to alert a guest 126 that a coupon 128 was printed and still in the output device. For example, the device transmits a beeping sound and a light flashes. In another example, a card reading device such as 120a and 120b includes audio means to alert a guest to remove a card from the device.

One or a plurality of personal communication devices 106 include devices such as a telephone, PDA, and pager, among others. Each personal communication device serves as a means by which a guest 126 can be notified in real-time of additional incentives such as time sensitive incentives. For example, a guest, after providing a valid number and/or email address, receives an automated voice call, a text message, or an email identifying additional incentives. Included in the message may be a unique PIN number that the guest can use to receive the incentive. If the guest desires any or all incentives, the guest can visit an access point such as a kiosk 104 or room 102 to print the coupon 128 associated with the incentive using an output device such as 122a and 122b.

For example, restaurant A is offering a two for one dinner incentive to certain guests 126, where the incentive is valid only for two hours. Data regarding this incentive is transmitted through one or a plurality of host systems such as PCS 100 to one or a plurality of personal communication devices 106, each identified as belonging to a guest, thereby notifying a guest of the incentive. Thereafter, the guest, using components of the system in an access point such as the guest's room 102 or kiosk 104, optionally may generate a coupon 128.

In another example, four seats became available at the last minute for a sold-out comedy show. As with the previous example, data regarding such availability is transmitted through one or a plurality of host systems such as PCS 100 to one or a plurality of personal communication devices 106, each identified as belonging to a guest 126. After a guest is notified of the seat availability, the guest may purchase the seats and optionally, using components of the system either in the guest's room 102 or kiosk 104 generate a coupon 128.

FIG. 2 is an illustration of components for the redemption of incentives and/or promotional coupons from a guest in accordance with an exemplary embodiment of the present invention. Any component or combination of components may be optional.

Illustrated is a plurality of host systems using a network 114 connection to interface with each other as well as one or a plurality of points of redemption 202 such as a game 204, kiosk 206, point-of-sale (“POS”) location 208, and lodging 210. Each point of redemption may include any or all components such as a card reading device such as 120a disclosed in FIG. 1 as well as throughout this specification.

The one or a plurality of host systems includes systems such as a PCS 100, LMS 110, and Others 112, all described in detail in FIG. 1 as well as throughout this specification.

In the operation of one embodiment, a guest 126 desiring to redeem a coupon 128 presents the coupon at a point of redemption 202 such as a POS 208. The point of redemption using a network 114 connection interfaces with one or a plurality of host systems such as the PCS 100 to process redemption data. The redemption data may include information on the incentive from the PCS as well as information on the guest from the LMS 110, among others. The one or a plurality of host systems also may validate any or all the data necessary for the redemption of the coupon. Data is transmitted back to the point of redemption from one or a plurality of host systems to allow for the redemption of the coupon.

For example, a guest 126 views an incentive for a discounted dinner for two. The guest selects the incentive and receives a coupon 128 generated by an output device (such as 122a of FIG. 1) for the incentive. Upon visiting the restaurant, the guest presents the coupon for redemption. The restaurant, having means to process the coupon such as a bill acceptor to accept the coupon and any or all components disclosed throughout this specification and known to those skilled in the art, uses a network 114 connection to process the redemption of the coupon. The processing may include interfacing with a PCS 100 for coupon data verification, interfacing with a LMS 110 for guest information verification, and interfacing with Others 112, for instance, to process accounting data.

In another embodiment, any or all components of a point of redemption 202 include audio and/or visual means for guest notification. For example, an output device (such as 122a of FIG. 1) includes audio and visual means to alert a guest 126 that a coupon 128 was printed and still in the output device. For example, the device transmits a beeping sound and a light flashes. In another example, a card reading device (such as 120a of FIG. 1) includes audio means to alert a guest to remove a card from the device.

FIG. 3 is an illustration of components for secured guest services in accordance with an exemplary embodiment of the present invention. Any component or combination of components may be optional.

Illustrated is a plurality of host systems such as PCS 100, LMS 110, and Other(s) 112 using a network 114 connection to interface with each other as well as one or a plurality of access points such as a room 102 and a kiosk 104. Additional access points include one or a plurality of personal communication devices (106 of FIG. 1) and a game (not shown), among others. Additional details on each component are disclosed throughout this specification.

Security means to prevent and/or deter unauthorized access, use, fraud and theft, includes any or a combination of the following, among others: a PIN, a password, associating a unique printer identifier with a room number, player tracking card data and/or other data, reading a card such as a room card and/or player tracking card, including the guest's (126 of FIG. 1) name on and/or with all financial transactions including printing of coupons (128 of FIG. 1). The security means ensure that incentives and/or play credits only issue to the guest.

In one embodiment, security means include providing a guest (126 of FIG. 1) with a PIN number and/or password that can be used to access the guest services system where the guest can view and select incentives as well as purchase play credits, among others. For instance, a PIN number and/or password can be requested by the LMS 110 during guest check-in and issued by the PCS 100. While in their room 102, the guest can access the system using a user interface 116a such as a television and input device 118a or a computer 128 where they enter the PIN number and/or password which is transmitted using a network 114 connection to the PCS for verification. If the PIN number and/or password are verified, the PCS transmits one or a plurality of incentives to the guest's room and the guest is granted access to view and select incentives. Once the guest requests to receive one or more incentives, the request is transmitted to the PCS which in turn transmits data back to the room through the controller 124a to an output device 122a such as a coupon printing device. Further, data regarding the print job is transmitted back to the PCS.

In another example, a guest (126 of FIG. 1) with a PIN number and/or password accesses the system using components of a kiosk 104 such as user interface 116b, card reading device 120b, and input device 118b. The PIN number and/or password are transmitted through the controller 124b to one or a plurality of host systems for verification.

In another embodiment, security means include using the room card or player tracking card of the guest (126 of FIG. 1) to grant access to the system. For example, after the guest uses a card reading device such as 120a or 120b to read their room card or player tracking card, data regarding the card such as room number, guest name, player ID, etc. is transmitted using a network 114 connection to, for example, the LMS 110 for verification. Additionally, data such as an identifier of any or all components of the system, such as card reading device identifier, is transmitted to the PCS 100 for verification. Once all data is verified, the PCS transmits one or a plurality of incentives to the access point such as the guest's room 102 and the guest is granted access to view and select incentives.

For example, if the room number and a component identifier do not match, one or a plurality of host system such as the LMS 110 and PCS 100 is notified, thereby preventing potentially unauthorized access to the system. Additionally, to prevent further use of the card within the system, the PCS transmits data back to the access point and data is written to the card rendering the card useless in the system after which the card can be ejected from a card reading device such as 120a and 120b, and/or the card is confiscated and stored in a secured location, for example, a card storage location of a card reading device. Additionally, an output device 122a and 122b such as a coupon printing device can generate an invalid card message containing instructions on how to retrieve the card.

In another embodiment, security means include associating a unique identifier for each component with an access point such as a room 102 or kiosk 104. A unique identifier can be an IP address, MAC address, and/or a unique address associated with the component, such as the IP address of an output device 122a and 122b or a combination of any or all. Additionally, each component in an access point also may be associated with each other. One benefit to this is that a gaming establishment readily can determine the location of the access point as well as the components of that access point. For instance, if an unauthorized attempt was made to relocate a component from the associated access point and reconnect the component at another access point, data regarding the component's disconnection, relocation and reconnection to the system is posted in the system. Additionally, this data may be flagged in the system, thereby preventing the component reconnection and/or use without proper authorization.

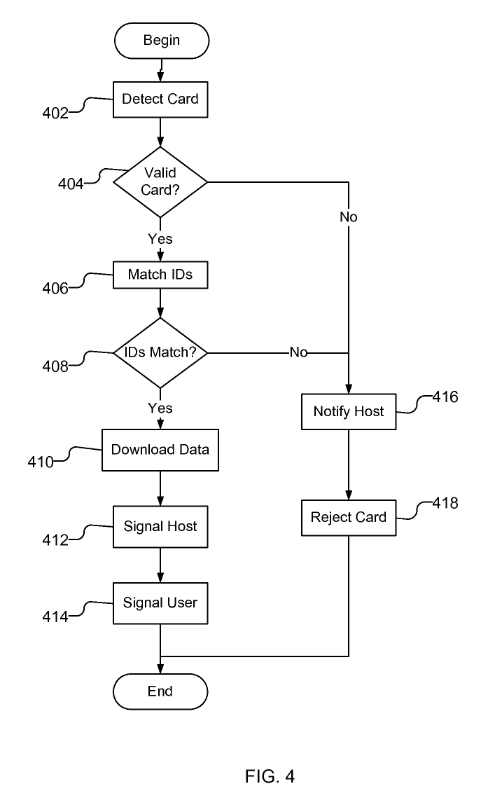

FIG. 4 is a flowchart of a data comparison and verification process to initiate secured guest services in accordance with an exemplary embodiment of the present invention.

As illustrated, the process begins with detect card 402 where a card reading device (such as 120a of FIG. 1) detected the presence of a card such as a room card or player tracking card. A determination is made to verify and/or validate 404 the card. If the card is verified and/or validated, the process continues with match IDs 406. In match IDs, data such as the room number, player tracking number, or another unique identifier for the card is transmitted back to one or a plurality of host system such as the LMS 110 and PCS 100 (both of FIG. 1), along with the access point identifier and/or component identifier after which a determination is made to identifier match.

If the identifiers, such as card identifier and component identifier match 408, the process continues with download data 410 where the PCS (100 of FIG. 1) transmits data regarding one or a plurality of incentives to the access point. The PCS and/or other host systems are signaled 412 as to the completion of the data download. The process ends with the guest is signaled 414 of the availability of incentives. In one embodiment, the signaling including audio and/or visual means.

If the card is not a valid card and/or the identifiers do not match, one or a plurality of host systems are signaled 416 and the card is rejected 418, for example, as disclosed in FIG. 3.

FIG. 5 is an illustration of components for play credits in accordance with an exemplary embodiment of the present invention. Any component or combination of components may be optional.

In an embodiment, methods and apparatus for guest services includes providing incentives to a guest (126 of FIG. 1), the incentives include the ability to request and purchase play credits, where the play credits include discounted play credits and/or bonus play credits, among others.

Illustrated is a plurality of host systems such as PCS 100, LMS 110, Gaming System(s) 502, Credit Card System 504 and Other(s) 112 using a network 114 connection to interface with each other as well as one or a plurality of access points 506 such as a room 102 and a kiosk 104 (both of FIG. 1). Additional access points include a game (not shown), among others.

The one or a plurality of host systems includes systems such as PCS 100 for the issuance, redemption, and management of promotional coupons, LMS 110 for the management of lodging and/or guest services, Gaming System(s) 502 for the management of games such as slots and table games, Credit Card System 504 to process credit and/or debit card financial transactions, and Others 112 such as an accounting system. These host systems interface with each other, access points 506, and/or points of redemption (202 of FIG. 2) for data exchange using a network 114. The network is one or a combination of networks such as a LAN, WAN, and Internet, among others.

Each room 102 and kiosk 104 (both of FIG. 1) serves as an access point 506, including devices and/or components which a guest (126 of FIG. 1) uses to interface with the guest services system for couponing and gaming. These devices and/or components include one or a plurality of user interfaces 508, one or a plurality of input devices 510, a card reading device 512, an output device 514, computer 518 as well a controller 516 for interfacing with one or a plurality of devices and one or a plurality of host systems such as PCS 100 using the network 114. Additional details on each are disclosed in FIG. 1 and throughout this specification.

In the operation of one embodiment, a guest (126 of FIG. 1) desires to purchase play credits. The guest using a connection such as that at an access point 506 such as provided in the guest's room and/or via a kiosk requests and purchases the additional play credits at face value, at a discounted cost, or as bonus credits. After the guest's request is approved, an output device 514 in an access point such as a room or kiosk generates one or a plurality of coupons (128 of FIG. 1) containing the play credits. Indicia may include a barcode, validation text, number and/or string, among others. A gaming establishment may vary the discount and/or bonus incentive based on play and/or other metrics for the guest. Additional detail is disclosed in FIG. 5 and FIG. 6 as well as throughout this specification.

In another embodiment, a card reading device 512 serves as a means by which purchased play credits and/or incentives are placed on a card such as a player tracking card. Further, a guest (126 of FIG. 1) may receive a unique PIN number to permit data exchange with the card. The guest can insert their card into a card reader in an access point 506 such as a kiosk, game, point-of-purchase location, etc., where the card can be read for redemption.

For example, a guest (126 of FIG. 1) can purchase $1 play credits at a discount of $0.85 or a guest can purchase $100 of play credits and receive bonus credits such as $15 where the issued amount totals $115.

In the operation of another embodiment, a guest (126 of FIG. 1) desires to purchase play credits. The guest uses their credit or debit card with a card reading device 512 at an access point 506. The card reading devices reads the card and using a network 114 connection via a controller 516 transmits data to a Credit Card System 504 for verification, validation and/or purchase approval. The Credit Card System transmits transaction approval and/or denial data back to the originating access point and/or one or a plurality of host systems. For example, if approved, data regarding the approval is transmitted to the Gaming System 502 to issue the play credits and to Other(s) 112 such as an accounting system to log the financial transaction. Additionally, the data is transmitted to the LMS 110 to log into the guest's record.

In another embodiment, the financial transaction card used during guest check-in is set as the default financial transaction card, thereby eliminating the need for a card reading device such as 512 to read the card. A variety of security means such as a PIN number and/or password, among others prevents unauthorized use of the credit or debit card.

FIG. 6 is a flowchart of a request play credits process in accordance with an exemplary embodiment of the present invention.

As illustrated, the process begins with access system 602 where a guest (126 of FIG. 1) using an access point (506 of FIG. 5) such as their room or a kiosk accesses the guest services system for couponing and gaming. The access can include security means such as a PIN number and/or password. The guest submits a request to purchase play credits 604. A determination is made to authorize 606 the purchase, for example by the Credit Card System (504 of FIG. 5). If the purchase is authorized and/or approved, the play credits are issued 608, for example by the Gaming System (502 of FIG. 5). Optionally, bonus play credits are issued 610. The process ends with notify host(s) 612 where one or a plurality of host systems (such as 112 of FIG. 1) are notified of the transaction.

If the purchase is not authorized and/or approved, the process continues with notify host(s) 614 where one or a plurality of host systems (such as 112 of FIG. 1) is notified of the denied transaction. The process ends with notify user 616 where the guest (or unauthorized party) is notified of the denied transaction.

FIG. 7 is a block diagram of a printer used with guest services in accordance with an exemplary embodiment of the present invention.

A printer 700 contains the programming instructions 702 and memory 704, among others necessary for signaling, data transfer and printing of one or a plurality of coupons (128 of FIG. 1) for incentives and/or play credits.

A printer 700 includes a processor 706, operatively coupled via a bus 708 to a memory 704. The processor is further operatively coupled via the bus to a storage device 710. Program instructions 702 and data 712 implementing previously described guest services system for couponing and gaming are stored in the storage device until the processor retrieves the program instructions and stores them in the memory. The processor then executes the program instructions stored in the memory and uses the data to implement the printing features of the guest services system for couponing and gaming.

The processor 706 is further coupled via the bus 708 to one or a plurality of communication devices or ports 714. The printer uses the communication devices to securely transmit and receive control signals and/or data to and from any external device such as a controller, a host system (such as 124a and 100 of FIG. 1), gaming system, gaming machine, among others.

The processor 706 is further coupled via the system bus 708 to a print device 716. The printer 700 uses the print device to generate coupons (128 of FIG. 1) as previously described.

The foregoing description of the components of printer 700 is provided by way of example and not of limitation, it being understood that printer could be implemented in a variety of ways without deviating from the spirit of the invention. For example, the processor 706 could be constructed from hardware such as hardwired circuits within a controller. Alternatively, printer could also be constructed from a combination of hardware and software components.

FIG. 8 is a block diagram of a card reading device used with guest services in accordance with an exemplary embodiment of the present invention.

A card reading device 800 contains the programming instructions 802 and memory 804, among others necessary for signaling, data transfer, and reading and writing of one or a plurality of cards, such as a room card, player tracking card, and credit card, among others.

A card reading device 800 includes a processor 806, operatively coupled via a bus 808 to a memory 804. The processor is further operatively coupled via the bus to a storage device 810. Program instructions 802 and data 812 implementing previously described guest services system for couponing and gaming are stored in the storage device until the processor retrieves the program instructions and stores them in the memory. The processor then executes the program instructions stored in the memory and uses the data to implement the features of the guest services system for couponing and gaming.

The processor 806 is further coupled via the bus 808 to one or a plurality of communication devices or ports 814. The card reading device 800 uses the communication devices to securely transmit and receive control signals and/or data to and from any external device such as a controller, a host system (such as 124a and 100 of FIG. 1), gaming system, gaming machine, among others.

The foregoing description of the components of card reading device 800 is provided by way of example and not of limitation, it being understood that card reading device could be implemented in a variety of ways without deviating from the spirit of the invention. For example, the processor 806 could be constructed from hardware such as hardwired circuits within a controller. Alternatively, card reading device could also be constructed from a combination of hardware and software components.

FIG. 9 is a block diagram of a host system used with guest services in accordance with an exemplary embodiment of the present invention.

A host system 900 contains the programming instructions 902, memory 904, security interface means, among others necessary for signaling and data transfer of one or a plurality of files for data verification and other purposes. Any exemplary host system is a PCS (100 of FIG. 1) used to create, manage and track the issuance and redemption of promotional coupons (128 of FIG. 1).

A host system 900 includes a processor 906, operatively coupled via a bus 908 to a memory 904. The processor is further operatively coupled via the bus to a storage device 910. Program instructions 902 and data 912 for implementing guest service processes are stored in the storage device until the processor retrieves the program instructions and stores them in the memory. The processor then executes the program instructions stored in the memory and uses the data to implement the features of the guest services.

The processor 906 is further coupled via the bus 908 to one or a plurality of communications devices or ports 914. The host system 900 uses the communications devices to securely transmit and receive control signals and/or data to and from external devices as previously described.

The processor 906 is further coupled via the bus 908 to one or a plurality of user input devices 916 and one or a plurality of user output devices 918 for communicating with a user as previously described for guest services.

The foregoing description of the components of host system 900 is provided by way of example and not of limitation, it being understood that host system could be implemented in a variety of ways without deviating from the spirit of the invention. For example, the processor 906 could be constructed from hardware such as hardwired circuits within a controller. Alternatively, host system could also be constructed from a combination of hardware and software components.

FIG. 10 is a side cutaway view of a printer illustrating the paper path used with the generation of incentives and/or promotional coupons in accordance with an exemplary embodiment of the present invention.

Illustrated are the media tray 1002, the PCB 1004, the print module 1006, a print head 1008, a media path 1010, a front aperture 1012, the base 1014, a lid 1016, and a lid aperture 1018.

The media tray 1002 stores blank media for use with printing. The PCB 1004 contains the electronics and components such as memory (704 of FIG. 7) as well as those previously disclosed necessary to drive the printing processes such generating vouchers and coupons (128 of FIG. 1), among other printing processes and interfacing with external devices such as a host system (900 of FIG. 9), game, routing device and handheld device, among others.

The print module 1006 serves as casing for the print head 1008, media path 1010 and rollers 1020, among others. The print head generates indicia on the blank media. The media path consists of a plurality of components such as a series of pinch rollers, covered in a flexible material, with accompanying mechanical guides. The pinch rollers and mechanical guides provide a serpentine path for media as the media is being printed. The pinch rollers pull the media through the media path as the media is being printed by the print head. The overall length of the serpentine path is such that media can be held within the media path after media has been fully printed.

The print module 1006 also contains an aperture 1012 located to the front of the print module. Printed media such as a coupon (128 of FIG. 1) or voucher exits through this aperture.

The base 1014 of the printer 700 provides the means by which the printer mounts to a game, kiosk, or other. The print module 1006 and other components of the printer are slidably and removably connected to the base for ease of use and servicing.

In the operation of one embodiment, blank media is loaded and stored in the media tray 1002 and fed into the lid aperture 1018 of the lid 1016 where the blank media is ready for printing. Upon receiving a print command, the printer 700 pulls the blank media through the lid aperture over the print head 1008 and generates an image and/or indicia to be printed on the media and operates the print mechanism in a manner that creates the image and/or indicia on the media. The media continues through the media path 1018 in the print module 1006 and exits through the front aperture 1012.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

### Appendix A—List of Terms

For the purposes of this document, the following definitions apply:
“Gaming Establishment”—A gaming entity such as a casino.
“Game”, “Gaming Machine”, or “Game Machine”—A slot machine, gaming machine, or game table in a gaming establishment.
“PCS”—Acronym for Promotional Coupon System, a system for the management, issuance, tracking and/or redemption of promotional coupons.
“LMS”—Acronym for Lodging Management System, a system for the tracking and management of lodging, among others.
“Host System”—A computer, back-end system, gaming system, network, or other system that sends and/or receives information to and/or from a game, a printer or other component in a game, gaming table, access point and/or point of redemption. Examples of a host system include a wagering issuance and redemption system, cash-out voucher system, a player tracking system, and a promotional coupon system, among others.
“Point of Redemption”—Any room, kiosk, point-of-sale, cashier's cage, or other means whereby a guest can redeem a game voucher, promotional coupon, progressive coupon, or temporary player club registration tickets.
“Game Voucher”, “Game Cashout Voucher” or “Voucher”—Media, such as paper or rewritable card, containing sufficient information to identify at a minimum, an amount of money and a validation number used to authenticate the transaction.
“Promotional Coupon”, “Progressive Coupon” or “Coupon”—Media, such as paper or rewritable card, containing sufficient information to identify at a minimum, a promotional event or a promotional reward to a player and validation information.

What is claimed is:

1. A system for couponing and gaming, comprising:
a promotional couponing system;
an access point for viewing, requesting, and receiving incentives and play credits;
a point of redemption for redeeming incentives and play credits;
a connection between an access point and a promotional couponing system for signaling and data transmission; and
a connection between a point of redemption and a promotional couponing system for signaling and data transmission.
